(19) United States
(12) Patent Application Publication
(10) Pub. No.: US 2006/0129377 A1
(43) Pub. Date: Jun. 15, 2006

(54) Tread or track with mirror image word pattern and method of printing on surface

(76) Inventor: Peter Damian Nash, Moab, UT (US)

Correspondence Address: PATTON BOGGS, 1660 LINCOLN ST, SUITE 2050, DENVER, CO, 80264, US

(21) Appl. No.: 11/305,482

(22) Filed: Dec. 15, 2005

Related U.S. Application Data
(60) Provisional application No. 60/636,585, filed on Dec. 15, 2004.

(51) Int. Cl. G06F 17/28

(52) U.S. Cl. 704/2

(57) ABSTRACT

A tire tread or track tread that is constructed in tessellating patterns of mirror images of words, phrases, or sentences suitable for communicating a person's identity or for advertising purposes. The treads imprint the earth or paint the road with the desired words, phrases, or sentences, adding an additional function to a car or other vehicle by converting it into a “printing press” for customized messages. Tires or tracks may be customized with treads comprising an art object, letter, numeral, word, phrase, sentence or logo.

### CROSS-REFERENCE TO RELATED APPLICATIONS

This Application is a Non-Provisional application of U.S. Provisional (35 USC 119(e)) Application No. 60/636585 filed on Dec. 15, 2004 and claims benefit thereto.

### FIELD OF THE INVENTION

The invention relates to the field of tire treads or other structures that support vehicles, such as snowmobile, tank, or tractor treads, and in particular to such tread or tracks with repeating patterns.

### BACKGROUND OF THE INVENTION

In this disclosure, the word “tread” is intended to cover both the common tire treads and other vehicle structures that contact the ground to propel the vehicle and are capable of leaving an imprint, such as snowmobile, tank tractor, bulldozer, or other machine treads or tracks, etc. Nearly all treads utilize a repeating pattern, and often the pattern is a “tessellation.” A tessellating design is a repeating pattern that can be used to cover a flat surface. For example, bathroom tile designs are considered tessellations. Most tessellation designs are geometric patterns such as squares, rectangles, triangles, etc. Tire designs are also usually tessellations.

A person's transportation has long been a source of pride and identity since man first began riding horses and other animals. This has continued to the era of motorized vehicles, and in recent years has increased greatly. Automobile and other vehicle manufactures have learned that sales can be greatly increased by appealing to the vehicle owner's desire to express his or her identity with the vehicle. For example, vehicles have been given paint designs, grills, chrome accessories, custom wheels or hubcaps, “vanity” license plates and other features solely geared toward giving the vehicle a special identity. Tires have also been used to provide identity, such as monster tires that are far larger than any transportation purpose might dictate, or small tires that give the vehicle a low-slung appearance. Tire tread designs that include representational art objects, letters, or written words that express some facet of the owner's or manufacturer's identity are known. See, for example, U.S. Design Pat. No. 405,728 issued Feb. 16, 1999; No. 47,944 issued Oct. 12, 1915; No. 278,994 issued May 28, 1985; No. 73,506 issued Sep. 20, 1927; No. 47,612 issued Jul. 20, 1915; No. 262,788 issued Jan. 26, 1982; No. 61,432 issued Sep. 15, 1922; No. 53,511 issued Jul. 8, 1919; No. 57,842 issued May 10, 1921; No. 44,050 issued May 20, 1913; No. 57,881 issued May 17, 1921; and U.S. Pat. No. 1,093,310 issued Apr. 14, 1914. However, the words written on these tire treads can be read only in the showroom. Once the tires are on the vehicle, they are legible only by looking directly at the tread design, which is not readily apparent except from certain unusual viewpoints, so the treads are, for all practical purposes, essentially unintelligible. Thus, they are not really effective for expressing communications, and have not received popular acceptance or the support of the tire industry.

Thus, it would be highly desirable to have a tire or track that is more effective in satisfying the need felt for special identity in customizing and personalizing vehicles.

### BRIEF SUMMARY OF THE INVENTION

The present invention overcomes the problems outlined by providing treads that act as printing presses, “imprinting” the earth, snow, wet road, or other surface over which they travel with written communications, logos, or combinations thereof, and leaving a visible track that satisfies the vehicle owner's need felt for special identity related to the vehicle.

The invention provides a tire or other vehicle track comprising: a tire or track body and a tread attached to the tire or track body, the track constructed in the form of the mirror image of a word, phrase, or sentence. Preferably, the word, phrase, or sentence is repeated to form a tessellated design. Preferably, the tread is capable of leaving an imprint on a surface over which the vehicle travels, the imprint comprising a normal orientation of the word, phrase, or sentence. Preferably, the word, phrase, or sentence is also on the sidewall of the tire or other vehicle track in normal orientation. Preferably, the word, phrase, or sentence is in normal orientation on the sidewall. Preferably, the word, phrase, or sentence runs continuously from the tread to the sidewall The word, phrase or sentence maybe in any writing system, and may include numerals. Preferably, the word, phrase, or sentence is formed in an alphabet selected from the group consisting of Latin, including European additions, Hebrew, Arabic, Greek and Russian. Preferably, the word, phrase, or sentence is formed in Kanji. Preferably, the word, phrase, or sentence forms all or part of a logo. Preferably, the word, phrase or sentence maybe in any language. Preferably, said word, phrase, or sentence is in a language selected from English, Spanish, German, French, Italan, Japanese, or Chinese.

The invention also provides a method of imprinting a word, phrase, or sentence on a surface, the method comprising: placing a tire or track on a vehicle, the tire or track having a tread in the form of the mirror image of a word, phrase, or sentence; and moving the vehicle over the surface in a manner such that the word, phrase, or sentence are written on the surface.

In another aspect, the invention provides a method of manufacturing a tire or vehicle track comprising: making a tire or track body, and constructing on the tire or track body a tread having a mirror image of a word, phrase, or sentence. Preferably, the method further includes, prior to the making and constructing, customizing a tread or track design having the word, phrase, or sentence. Preferably, the method further includes forming the word, phrase, or sentence on the sidewall of the tire or other vehicle track. Preferably, the forming comprises forming the word, phrase, or sentence in normal orientation on the sidewall. Preferably, the method further includes continuously forming the word, phrase, or sentence from the tread to the sidewall Preferably, the word, phrase, or sentence is in the Arabic alphabet. Preferably, the word, phrase, or sentence is in Kanji.

In another aspect, the invention provides a business method comprising: conferring with a customer entity to design a custom tire or track tread; making a mold of a tire or track with the custom tread, the tread comprising an art object, letter, numeral, word, phrase, sentence, or logo; and making a tire with the mold. Preferably, the making a mold comprises: storing a plurality of premanufactured letters, numerals, and art objects; and inserting a plurality of the premanufactured letters, numerals, and art objects in the tire mold.

The invention not only provides a new apparatus and method for identity expression and advertising, but it usually does so in a manner that is compatible with the traditional needs of traction and durability in that the tessellating patterns can be adjusted to fit the engineering specifications for the intended use of the tire or track. Numerous other features, objects, and advantages of the invention will become apparent from the following description when read in, conjunction with the accompanying drawings.

### BRIEF DESCRIPTION OF THE DRAWINGS

FIG. 1 shows a conventional prior art tire tread and tire mounted on a wheel;

FIG. 2 shows an all weather tire having an exemplary tread pattern design based on the words “kick ass” and the imprint left by the tire;

FIG. 3 shows an off-road tire having an exemplary tread pattern design based on the words “kick ass” and the imprint left by the tire;

FIG. 4 shows a tire having an exemplary Kanji tread pattern design based on the Kanji written symbol for peace and harmony and the imprint left by the tire;

FIG. 5 shows a tire having an exemplary all-weather tread pattern design based on the famous Chevrolet™ logo, arranged so that the spaces between the logos suggest a lightening bolt and the imprint left by the tire which includes word “Chevrolet” ; and

FIG. 6 shows flattened plan view of another exemplary logo tire tread design based on the famous Chevrolet™ logo that would be suitable for a racing slick

### DETAILED DESCRIPTION OF THE INVENTION

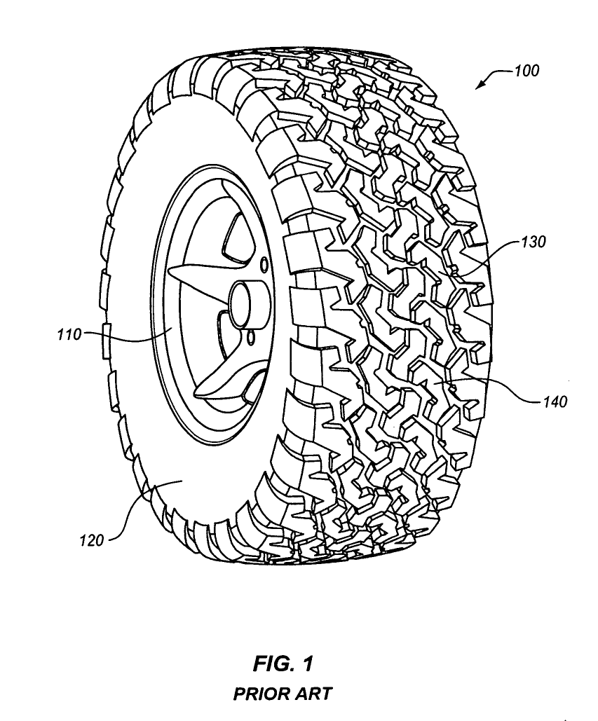

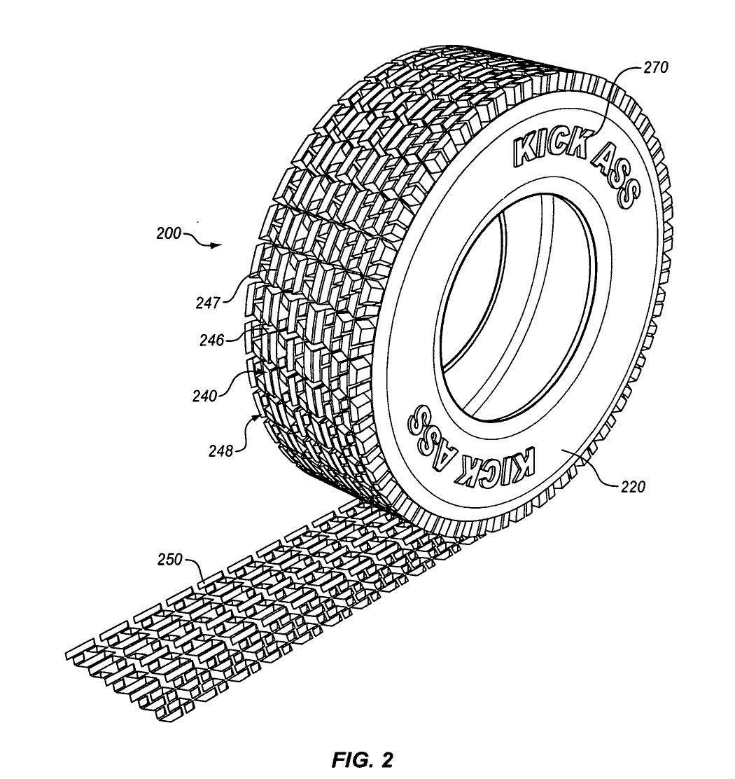

FIG. 1 shows a conventional tire 100 mounted on a wheel 110. Tire 100 includes a tread 130 and a sidewall 120. Tread 130 is in the form of a tessellating pattern 140. FIG. 2 shows a tire 200 having an exemplary tread pattern 240 that is in the form of writing 248 and the imprint 250 left by the tire. The written phrase 248 is the mirror image of the slang term “kick ass”, a term that has several popular meanings. As used by young people today, it usually means “outstanding” or “super”. The tread 240 of this tire 200 has many grooves 246 running perpendicular to the circumference of the tire, and other grooves 247 running along the circumference of the tire. These grooves serve to funnel water away from the center of the tire, and at the same time the letters are large enough to form lugs that provide excellent traction, making this tire particularly suited as a truck or mud tire. An important feature of the invention is that the tread pattern 240 is a mirror image of the word, sentence, or phrase that it is desired to communicate. Because the tread pattern 240 is a mirror image, the track 250 is an easily read, legible form of the phrase “kick ass”.

In this disclosure, the word “tread” is intended to cover both the common tire treads and other vehicle structures that contact the ground to propel the vehicle and are capable of leaving an imprint, such as snowmobile treads, tank, tractor, bulldozer, or other machine treads or tracks, etc. The term “tread” is limited to that portion of the tire, track, or other vehicle structure that is intended to actually be in contact with the earth, road, or other surface on which the vehicle travels. It specifically does not include the sidewall, such as 120 and 220, of a tire, track, or other such vehicle structure. However, the invention does include the feature that the sidewall can include the communication shown on the tread, but in normal, not mirror orientation. In this way, the tire can be more easily identified when it is not leaving a track.

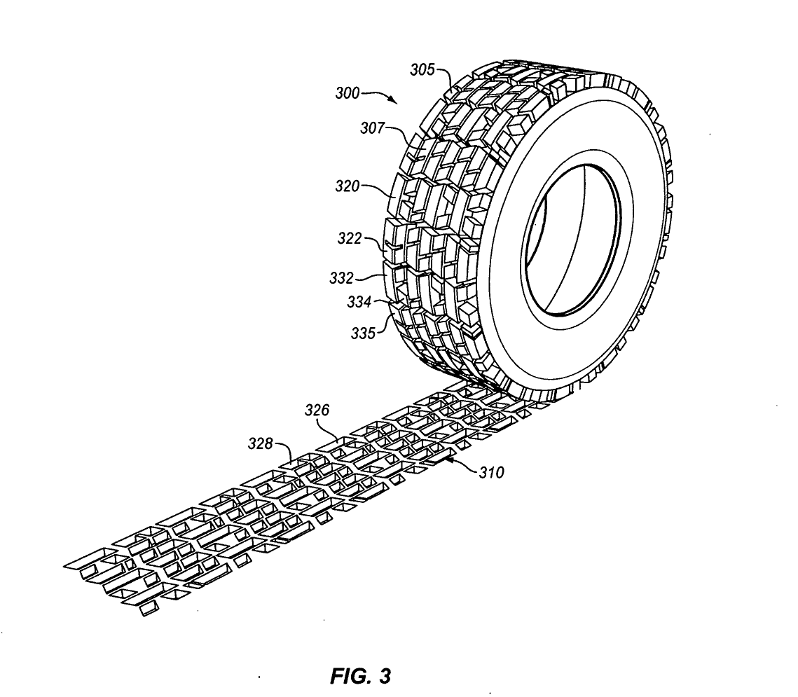

FIG. 3 shows a tire 300 with an alternative written tread pattern 305 which is a mirror image of the written words “KICK ASS!” 307 in which the words KICK 320 and ASS! 322 alternate around the circumference of the tire tread. Similarly, in the track 310 left by this tire, the words KICK 326 and ASS! 328 alternate in large print. The large lugs 332, 334, 335, etc. formed by each portion of the letters makes the tire 300 particularly well suited for ATVs, other off-road vehicles, and 4WD vehicles for muddy or sandy conditions. The extreme four-wheel-drive enthusiasts and monster truck owners might enjoy leaving words like “KICK ASS” in the mud behind them.

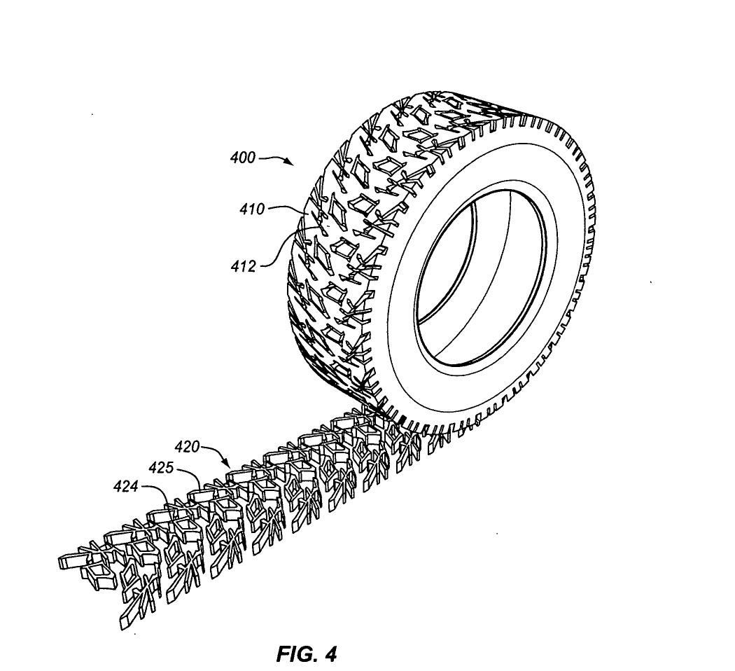

FIG. 4 shows a tire 400 with a written tread pattern 410, half of which is a mirror image of the Kanji (Japanese) writing symbol 412 for peace, which is also interpreted as harmony. The other half of the tread shows the writing in normal form, so that this tire tread both can leave a track that is legible and can be read by looking at the tread, which is particularly useful for store displays of the tire. Tire 400 leaves the track 420. This tire is different than the tires of FIGS. 2 and 3, not only because it uses a different writing form, but also because the characters are formed as grooves in the tread rather than raised portions of the tread as in the previous examples. Thus, the written characters 424 and 425 appear as raised ridges in the mud or snow rather than indentations as for characters 326 and 328.

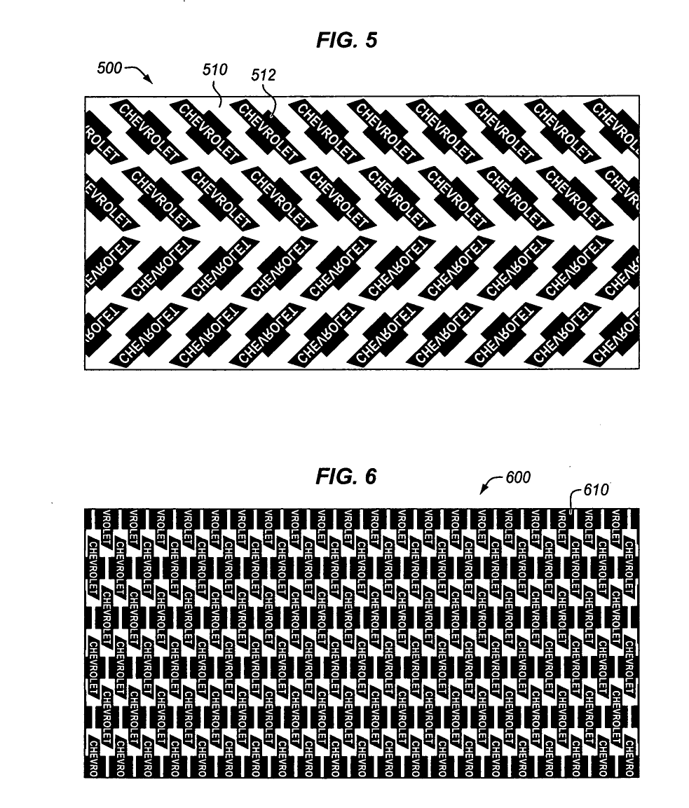

FIG. 5 shows a plan flattened view of tire tread 500 with a tread pattern 510 in the form of the mirror image of a famous logo, Le., the Chevrolet™ logo including the mirror image written word “Chevrolet” 512. Again half of this tread shows the mirror image, while the other half shows the normal image. Corporations, partnerships, educational institutions, sports teams, and individuals associated with such entities will enjoy expressing their identity in this manner. The particular logo of FIG. 5 is the famous Chevrolet™ “bow tie” design. In this tread 500, the logos are arranged so that the spaces between them create a representation of a bolt of lightening. With variations, this design would lend itself to a wide variety of tires. If the logo were made larger and spaced more widely, for example, it would be excellent for snow tires or off-road tires. If several rows of the logo were separated by grooves, it would lend itself to all-weather tires. If the logo were etched into an otherwise slick tread, it could enhance racing tires. FIG. 6 shows a flattened plan view of such a racing slick tread 600 including images 610 of the Chevrolet™ logo including the written word “Chevrolet”.

As other examples, words like “Grip” and “Power”can be written on tires in exotic mirror image fonts that fit together like puzzle pieces into a tessellating (tiling pattern As other examples, treads with “Jesus Loves You” or “Peace On Earth” designs would be highly coveted by people who would get great satisfaction from communicating these messages every time they drive through a puddle. Such phrases may or may not be tessellated. As further example, people may place mirror images of their initials on tire treads; or tessellated designs may include mirror images of one or more letters, integers, or other recognizable characters or symbols, particularly if these had special meaning to the vehicle owner.

The invention contemplates that the writing 249, 307, 412, 512 can be a written form that, in mirror image, communicates some aspect of the identity of the tire user, such as phone numbers, names, corporate names, slogans, prayers. If the writing is a prayer, the tire becomes akin to a prayer wheel used in some religions. That is, as the tire with a prayer on it turns, the prayer flies into the wind. Traditional sayings such as “Shalom:, “Salaam”, and “Peace” will be identity expressions that many will prefer. In this disclosure, the writing can be in any writing form, including Arabic, Cyrillic, and Kanji.

An important feature of the invention is that these new kinds of tires and treads “paint” the road with water after traveling through puddles, pattern the earth in mud, sand, or snow, and otherwise leave patterns of special meaning to the owner. The tread patterns according to the invention leave long trails of phrases or thoughts on the earth. The invention contemplates recognizable and/or legible tread designs for every application where human vehicle activity leaves marks upon the earth. Without limitation, these kinds of tread patterns can be used in the following areas: truck tire treads, monster truck tire treads, ATV tire treads, automobile tire treads, motorcycle tire treads, bike tire treads and particularly mountain bike tire treads, snowmobile treads, bulldozer and earth-moving machinery treads, tank treads, tractor treads, and all other machine treads.

It is contemplated that the patterns on the treads preferably will be continued or otherwise written along the sidewall of the tire or track, such as at 270 in FIG. 2, where they preferably are not in mirror image, but in normal image. In this way, the design that a particular tire or track tread has can be recognized without bending down and looking at the bottom of the tire. Placing the pattern on the sidewall also provides another way to express the user's identity or to advertise the pattern.

As illustrated above, highly desirable word-based tread patterns can be married with state-of-the-art utilitarian tread designs. Tire engineers will understand how to do this from this disclosure. Tread designs based on these ideas can simultaneously grip the road and provide a look and imprint that satisfies the vehicle owner's need for self-expression. The invention contemplates special manufacturing plants that create treads on demand for customers who prefer unique or limited edition tread designs for their vehicles. The word, phrase, or sentence may be in any alphabet or language. For example, the word, phrase, or sentence can be formed in an alphabet selected from the group consisting of Latin, including European additions, Hebrew, Arabic, Greek, and Russian. The word, phrase, or sentence, for example, can be in a language selected from English, Spanish, German, French, Italian, Japanese, or Chinese.

The invention also provides a new business method for tire companies and others, i.e., the business of making and selling tires with customized treads. Since the custom elements of the tread are letters in mirror image, a set of letters that can be imbedded in a tire mold can be stored, similar to the manner in which type is presently stored for printing. The letters can be both mirror image or normal image for melting imprinted images or images that can be read directly from the tread, as in a store display. In this aspect of the invention, the designs can be based on representational art objects (wizards, leaves, snakes, horses, birds, dragons, insects, mythical creatures, etc.) that leave identifiable art patterns as the imprint in the mud or as the watermark following a puddle. The designs can also be letter or numeral designs, where the tire treads leave legible letters, numerals, words, phrases, sentences, or messages as an imprint. The stored design elements will include representational art objects, letters, and numerals. The designs and stored design elements can be both in mirror image and in normal orientation.

The business method according to the invention works as follows. A potential customer or customer, which maybe a person or some other entity, such as a corporation, a partnership, school, university, a social or charitable organization or any other entity, confers with a person representing the business, which person is preferably trained in designing workable customized tire designs. The potential customer or customer shall be referred to herein as the “customer entity”. Using a computer database that includes the stored design elements, the business representative assists the entity in designing a tire that is expressive of the customer entity as the customer entity desires. The business representative preferably is trained to incorporate engineering aspects that will not only make a suitably expressive tire, but will make a tire that is practical, safe, and otherwise utilitarian as well.

The design is sent, preferably electronically, back to the factory, where a mold is made following the design, preferably by incorporating stored mold elements that follow the customized design. Using the stored mold elements, a mold is designed to create a tread in the form of an art object, letter, numeral, word, phrase, sentence, or logo. The tread can be in mirror image, such as FIG. 3, in normal image, such as FIG. 6, or a combination of minor and normal image, such as FIGS. 4 and 5. The mold is then used to make a customized tire.

The invention also contemplates that customized tire molds maybe made separately and individually without the use of stored mold elements. While the stored elements are useful for making one-of-a-kind tires more economical, in certain situations it will be economical to design tires totally from scratch for particular groups, such as a corporation, a partnership, school, university, a social or charitable organization or other entity. For example, an alumni organization of a university may arrange the manufacture of a special tire for its alumni, such as with the university initials, for example, MSU for Michigan State University alumni, or a university logo. In this case, there can be sufficient individual customers belonging to the organization to make a completely customized tire economical.

There have been described novel new tire and track constructions, treads, and methods for making treads, and methods of leaving patterns in earth and on roadways. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiments described without departing from the inventive concepts. The various elements maybe arranged differently, and the various processes of the method maybe performed in a different order. It is also evident that equivalent structures and processes may be substituted for the various structures and processes described. Consequently, the invention is to be construed as embracing each and every novel feature and novel combination of features present in and/or possessed by the tire and track construction, tread construction, tire manufacturing methods, and surface imprinting methods described.

What is claimed as new and desired to be protected by Letters Patent of the United States is:

1. A tire or other vehicle track comprising:
a tire or track body, and
a tread attached to said tire or track body, said track constructed in the form of the mirror image of a word, phrase, or sentence.

2. A tire or other vehicle track as in claim 1 wherein said word, phrase, or sentence is repeated to form a tessellated design.

3. A tire or other vehicle track as in claim 1 wherein said tread is capable of leaving an imprint on a surface over which said vehicle travels, said imprint comprising a normal orientation of said word, phrase, or sentence.

4. A tire or other vehicle track as in claim 1 wherein said word, phrase, or sentence is also on the sidewall of said tire or other vehicle track in normal orientation.

5. A tire or other vehicle track as in claim 4 wherein said word, phrase, or sentence is in normal orientation.

6. A tire or other vehicle track as in claim 1 wherein said word, phrase, or sentence runs continuously from said tread to said sidewall.

7. A tire or other vehicle track as in claim 1 wherein said word, phrase, or sentence is formed in an alphabet selected from the group consisting of the Latin, including European additions, Hebrew, Arabic, Greek, and Russian alphabets.

8. A tire or other vehicle track as in claim 1 wherein said word, phrase, or sentence is formed in Kanji.

9. A tire or other vehicle track as in claim 1 wherein said word, phrase, or sentence is in a language selected from English, Spanish, German, French, Italian, Japanese, or Chinese.

10. A tire or other vehicle track as in claim 1 wherein said word, phrase, or sentence forms all or part of a logo.

11. A method of imprinting a word, phrase, or sentence on a surface, said method comprising:
placing a tire or track on a vehicle, said tire or track having a tread in the form of the mirror image of a word, phrase, or sentence; and
moving said vehicle over said surface in a manner such that said word, phrase, or sentence are written on said surface.

12. A method of manufacturing a tire or vehicle track comprising:
making a tire or track body; and constructing on said body a tread having a mirror image of a word, phrase, or sentence.

13. A method as in claim 12 and further including prior to said making and constructing, customizing a tread or track design having said word, phrase, or sentence.

14. A method as in claim 12 and further including forming said word, phrase, or sentence on the sidewall of said tire or other vehicle track in normal orientation.

15. A method as in claim 12 and further including continuously forming said word, phrase, or sentence from said tread to said sidewall.

16. A method as in claim 12 wherein said word, phrase, or sentence is formed in an alphabet selected from the group consisting of the Latin, including European additions, Hebrew, Arabic, Greek, and Russian alphabets.

17. A method as in claim 12 wherein said word, phrase, or sentence is in a language selected from English, Spanish, German, French, Italian, Japanese, or Chinese.

18. A method as in claim 12 wherein said word, phrase, or sentence is in Kanji.

19. A business method comprising:
conferring with a customer entity to develop a custom tire or track tread;
making a mold of a tire or track with said custom tread, said tread comprising an art object, letter, numeral, word, phrase, sentence, or logo; and
making a tire with said mold.

20. A business method as in claim 19 wherein said making a mold comprises:
storing a plurality of premanufactured letters, numerals, and art objects; and
inserting a plurality of said premanufactured letters, numerals, and art objects in said tire mold.
